(19) United States
(12) Patent Application Publication
(10) Pub. No.: US 2011/0198107 A1
(43) Pub. Date: Aug. 18, 2011

(54) FLAME RETARDANT, FLAME-RETARDANT COMPOSITION, AND INSULATED WIRE

(75) Inventor: Tsuyoshi Nonaka, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 13/124,994

(22) PCT Filed: Sep. 30, 2009
(86) PCT No.: PCT/JP2009/066997

§ 371 Date: Apr. 19, 2011

(30) Foreign Application Priority Data
Nov. 4, 2008 (JP) 2008-283350

(51) Int. Cl. H01B 7/295; C09K 21/14

(52) U.S. Cl. 174/110 SR; 524/436

(57) ABSTRACT

A flame retardant capable of improving cold resistance and manufacturability of a flame-retardant composition containing itself, and a flame-retardant composition and an insulated wire including the same. A flame retardant is prepared by subjecting an aggregation prepared by aggregating particles mainly consisting of magnesium hydroxide made from magnesium chloride contained in seawater to surface treatment using a surface treatment agent containing an organic polymer. The organic polymer is an olefin resin such as polyethylene and polypropylene. The organic polymer is a resin having a low melt viscosity or a low melting point, and specifically a resin having a melt viscosity of 1000 mPa·s or less at 140° C., or having a melting point of 100° C. or less. The flame-retardant composition contains the flame retardant and a matrix polymer. The insulated wire is prepared by covering a conductor with the composition.

### TECHNICAL FIELD

The present invention relates to a flame retardant, a flame-retardant composition and an insulated wire, and more specifically relates to a flame retardant suitably used as a flame-retardant material of a covering member of an insulated wire that is used for carrying out wiring of parts for automobile and parts for electrical/electronic appliance, and a flame-retardant composition and an insulated wire including the same.

### BACKGROUND ART

Conventionally, an insulated wire in which a vinyl chloride resin composition that contains a halogenous flame retardant as an additive covers a conductor is in widespread use as an insulated wire used for carrying out wiring of parts for automobile and parts for electrical/electronic appliance.

However, there is a problem that containing halogen elements, this kind of vinyl chloride resin composition emits enormous amounts of harmful halogenous gas into the atmosphere in case of car fire or at the time of disposing of the electrical/electronic appliance by incineration, causing environmental pollution.

Consequently, from the view point of reducing loads on the global environment, the vinyl chloride resin composition has been recently replaced with a so-called non-halogenous flame-retardant composition that contains an olefin resin that does not emit harmful halogenous gas into the atmosphere during incineration, and metal hydroxide such as magnesium hydroxide as a flame retardant.

For example, PTL1 discloses that a flame retardant prepared by pulverizing a natural mineral mainly consisting of magnesium hydroxide is used for a covering member of an insulated wire and a covering member of a cable. The flame retardant is subjected to surface treatment using a surface treatment agent mainly consisting of a fatty acid, a fatty-acid metallic salt, a silane coupling agent or a titanate coupling agent.

Magnesium hydroxide in a crystal growth state is conventionally used in the wire industry, which is prepared by growing crystal molecules of magnesium hydroxide that is made from magnesium chloride contained in seawater by reaction with calcium hydroxide in an aqueous solution.

Meanwhile, magnesium hydroxide in an aggregation state was once used not in the wire industry but in the steel industry for the sake of flue gas desulfurization, which is prepared by aggregating molecules of magnesium hydroxide that is made from magnesium chloride contained in seawater by using an aggregating agent.

### CITATION LIST

### Patent Literature

PTL1: JP 3339154 B

### SUMMARY OF INVENTION

### Technical Problem

However, there is a problem that the magnesium hydroxide in the crystal growth state that is conventionally used in the wire industry is more costly to manufacture compared with natural magnesium hydroxide, and is accordingly less available on the cost front.

In contrast, the magnesium hydroxide in the aggregation state has a manufacturing cost advantage over the magnesium hydroxide in the crystal growth state. However, the magnesium hydroxide in the aggregation state was once used only in the steel industry, which is totally different from the wire industry, for the sake of flue gas desulfurization. Using the magnesium hydroxide in the aggregation state as a flame retardant in the wire industry is inconceivable, and accordingly an attempt to use it has never been made.

Objects of the present invention are to provide a flame retardant having a nonconventional configuration that is capable of improving cold resistance and manufacturability of a flame-retardant composition containing the flame retardant, and to provide a flame-retardant composition and an insulated wire including the same.

### Solution to Problem

In order to solve the problem, the present inventor first made an attempt to mix the magnesium hydroxide in the aggregation state into a composition for a covering member of an insulated wire; however, he found that the prepared covering member did not have sufficient cold resistance. He also found that a discharge amount of the composition discharged from a kneader for kneading the composition during the composition preparation was small, and the composition accordingly has insufficient manufacturability. In addition, he made an attempt to subject the magnesium hydroxide in the aggregation state to surface treatment using a generally-used surface treatment agent cited in PTL1; however, he found that cold resistance and manufacturability of the composition were not improved enough. Based on these findings, the present inventor introduced further refinements into the magnesium hydroxide in the aggregation state in order to use in the wire industry, and finally brought the flame retardant to perfection.

That is, the flame retardant according to the present invention contains an aggregation of particles mainly consisting of magnesium hydroxide, and a surface treatment agent containing an organic polymer, with which a surface of the aggregation is coated.

It is preferable that the organic polymer is a resin having a melt viscosity of 1000 mPa·s or less at 140° C. It is preferable that the organic polymer is a resin having a melting point of 100° C. or less.

It is preferable that the organic polymer is an olefin resin that contains one or a plurality of materials selected from the group consisting of polyethylene, polypropylene, an ethylene-ethyl acrylate copolymer and an ethylene-vinyl acetate copolymer.

It is preferable that the surface treatment agent content is within a range of 0.1 to 10 parts by mass with respect to 100 parts by mass of the aggregation.

The flame-retardant composition according to the present invention contains the flame retardant and a matrix polymer. The insulated wire according to the present invention includes a conductor, and the flame-retardant composition with which the conductor is covered.

### Advantageous Effects of Invention

The flame retardant according to the preferred embodiment of the present invention allows improving cold resistance of the flame-retardant composition containing the flame retardant and the matrix polymer. This improvement is assumed to be made because subjecting the aggregations of the particles mainly consisting of the magnesium hydroxide, which have irregular surfaces because fine particles of the magnesium hydroxide are adhered thereto, to surface treatment using the surface treatment agent containing the organic polymer smooths out the surface irregularities better than subjecting them to surface treatment using a conventional surface treatment agent, and the aggregations less aggregate, whereby the flame retardant can be highly dispersed into the flame-retardant composition.

In addition, the flame retardant according to the preferred embodiment of the present invention allows increasing a discharge amount of the flame-retardant composition containing the flame retardant that is discharged from a kneader, whereby manufacturability of the flame-retardant composition can be improved. This improvement is assumed to be made because subjecting the aggregations to surface treatment using the surface treatment agent containing the organic polymer allows the flame retardant to be highly dispersed into the flame-retardant composition. In addition, this improvement is assumed to be made because the organic polymer is not easily pyrolyzed compared with a fatty acid that is a conventional surface treatment agent, and volatile gas that is generated by the pyrolysis less generates in the process of heat-kneading of the flame-retardant composition containing the flame retardant and the matrix polymer, whereby the materials can be smoothly supplied into the kneader.

If the resin having the specific melt viscosity is used as the organic polymer, the surface treatment agent adheres well to the aggregations to coat them uniformly. In addition, if the organic polymer has the specific melting point, the surface treatment agent adheres well to the aggregations to coat them uniformly. Thus, the effect of smoothing out the surface irregularities of the aggregations is further increased.

If the olefin resin is used as the organic polymer, it blends well with the matrix polymer that is made from an olefin resin, whereby the flame retardant can be further dispersed into the flame-retardant composition.

If the surface treatment agent content is within the specific range, cold resistance and manufacturability of the composition are further improved.

The flame-retardant composition according to the present invention, which contains the flame retardant and the matrix polymer, is excellent in cold resistance and manufacturability. The insulated wire according to the present invention is accordingly excellent in cold resistance and manufacturability.

### BRIEF DESCRIPTION OF DRAWINGS

FIG. 1 is a cross-sectional view showing a flame retardant according to a preferred embodiment of the present invention.

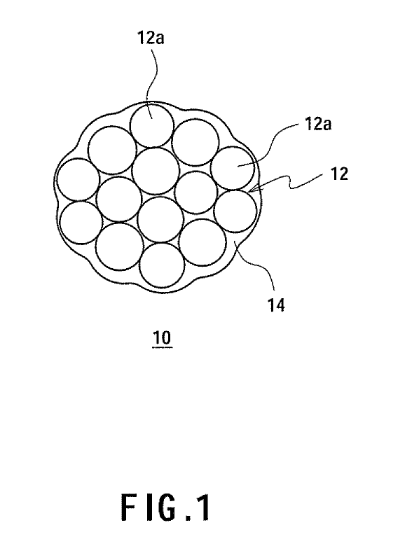

### DESCRIPTION OF EMBODIMENTS

A detailed description of a preferred embodiment of the present invention will now be provided. A flame retardant 10 according to the preferred embodiment of the present invention contains aggregations 12 of particles 12a mainly consisting of magnesium hydroxide, and a surface treatment agent 14 containing an organic polymer, with which surfaces of the aggregations 12 are coated.

The aggregations 12 are defined as a flame-retardant material, which mainly consist of magnesium hydroxide. The aggregations 12 are prepared by aggregating molecules mainly consisting of magnesium hydroxide that is prepared by precipitating (crystallizing) magnesium chloride contained in seawater by react ion with calcium hydroxide in an aqueous solution. In the reaction of the magnesium chloride and the calcium hydroxide in the aqueous solution, the precipitated (crystallized) magnesium hydroxide is microparticles having a very small diameter (in the submicron order). Thus, the magnesium hydroxide does not sediment but is suspended in the solution. The obtained microparticulate magnesium hydroxide, which cannot be separated from the water by filtration or other techniques, is aggregated by using an aggregating agent and can be separated as aggregations by sedimentation.

The aggregations 12, which are obtained by aggregating the particles 12a mainly consisting of the magnesium hydroxide, are each roughly spherical in shape, but have nonsmooth surfaces due to their production method.

The average diameter of the aggregations 12, which is not limited specifically, is preferably 0.1 μm or more considering its easy separation by sedimentation. On the other hand, the average diameter is preferably 20 μm or less considering that in using the magnesium hydroxide as a flame retardant for a covering member of an insulated wire, the covering member can be prevented from having marred surface appearance. The average diameter is more preferably within a range of 0.2 to 10 μm, and still more preferably within a range of 0.5 to 5 μm.

The surface treatment agent 14 that is used to subject the surfaces of the aggregations 12 to surface treatment contains the organic polymer. It is preferable that the surface treatment agent 14 further contains additives. Examples of the additives include an antioxidant.

The organic polymer of the surface treatment agent 14, which is not limited specifically, is preferably an olefin resin. Examples of the olefin resin include a homopolymer or a copolymer of olefin such as ethylene and propylene, and a copolymer of olefin and another monomer such as an acrylate monomer and a vinyl monomer. They may be used singly or in combination. To be specific, preferable examples of them include polyethylene (PE), polypropylene (PP), an ethylene-ethyl acrylate copolymer (EEA) and an ethylene-vinyl acetate copolymer (EVA).

Examples of the polyethylene include low density polyethylene, ultralow density polyethylene, linear low density polyethylene, high density polyethylene and metallocene polymerized polyethylene. They may be used singly or in combination.

A resin having a low melt viscosity is preferably used as the organic polymer of the surface treatment agent 14. This is because such a resin adheres well to the surfaces of the aggregations 12, and has a fine effect of uniformly coating the aggregations 12 to smooth their surfaces. To be specific, a resin having a melt viscosity of 1000 mPa·s or less at 140° C. is preferably used. A resin having a melt viscosity of 900 mPa·s or less is more preferably used, and a resin having a melt viscosity of 800 mPa·s or less is still more preferably used. Meanwhile, from the viewpoint of preservation stability, the melt viscosity of the organic polymer at 140° C. is preferably 10 mPa·s or more, more preferably 20 mPa·s or more, and still more preferably 30 mPa·s or more. The melt viscosity of the organic polymer can be measured preferably by a thermal analysis technique (e.g., DSC).

A resin having a low melting point is preferably used as the organic polymer of the surface treatment agent 14. This is because such a resin adheres well to the surfaces of the aggregations 12, and has a fine effect of uniformly coating the aggregations 12 to smooth their surfaces. To be specific, a resin having a melting point of 100° C. or less is preferably used. A resin having a melting point of 90° C. or less is more preferably used, and a resin having a melting point of 80° C. or less is still more preferably used. Meanwhile, from the viewpoint of preservation stability, the melting point of the organic polymer is preferably 40° C. or more, more preferably 50° C. or more, and still more preferably 60° C. or more. The melting point of the organic polymer can be measured preferably by a thermal analysis technique (e.g., DSC).

The organic polymer of the surface treatment agent 14 may be modified by acid. Examples of the acid include an unsaturated carboxylic acid and its derivative. To be specific, examples of the unsaturated carboxylic acid include a maleic acid and a fumaric acid. Examples of the derivative include a maleic acid anhydride, a maleic acid monoester and a maleic acid diester. Among them, the maleic acid and the maleic acid anhydride are preferably used. They may be used singly or in combination. The acid-modified organic polymer can blend well with the aggregations that are inorganic substances.

The acid is introduced into the organic polymer of the surface treatment agent 14 preferably by a grafting method or a direct method (copolymerization method). The amount of the acid-modified organic polymer is preferably 0.1 to 20% by mass with respect to the full amount of the organic polymer, more preferably 0.2 to 10% by mass, and still more preferably 0.2 to 5% by mass. If the amount is smaller than the lower limit, the effect of the organic polymer to develop an affinity with the aggregations tends to be lessened. If the amount is larger than the upper limit, the effect of the organic polymer to develop an affinity with the aggregations tends to be lessened.

The content of the surface treatment agent 14 in the flame retardant 10 is preferably within a range of 0.1 to 10 parts by mass with respect to 100 parts by mass of the aggregations 12. If the content is less than 0.1 parts by mass, the effect of the surface treatment agent 14 to smooth out the irregular surfaces of the aggregations 12 tends to be lessened. Therefore, the effect of improving cold resistance and manufacturability of a flame-retardant composition containing the flame retardant 10 and another organic polymer (matrix polymer) tends to be lessened. On the other hand, if the content is more than 10 parts by mass, while the effect of improving cold resistance and manufacturability of the flame-retardant composition is not influenced very much, an increase in cost is caused. The content of the surface treatment agent 14 is more preferably within a range of 0.5 to 5 parts by mass, and still more preferably within a range of 1 to 2 parts by mass.

In the flame retardant 10, the surface treatment agent 14 may coat the entire surfaces of the aggregations 12, or may coat portions of the surfaces of the aggregations 12. The thickness of the surface treatment agent 14 coated on the aggregations 12, which is not limited specifically, is preferably within a range of 0.001 to 0.01 μm.

A surface treatment method for subjecting the aggregations 12 to surface treatment using the surface treatment agent 14, which is not limited specifically, is preferably a wet method using a solvent for the organic polymer of the surface treatment agent 14, or a dry method using no solvent. In using the wet method, examples of the solvent preferably used include an aliphatic solvent such as pentane, hexane and heptane, and an aromatic solvent such as benzene, toluene and xylene. The surface treatment is performed preferably by soaking the aggregations 12 in the surface treatment agent 14 that is molten or dissolved, or by spraying the surface treatment agent 14 over the aggregations 12.

The aggregations 12 have the irregular surfaces in the flame retardant 10 as described above, so that the aggregations 12 tend to adhere to one another. When the flame retardant 10 is mixed into a composition containing an organic polymer (matrix polymer), for example, the aggregations 12, if not treated, are not easily dispersed into the composition. For this reason, the aggregations 12 are subjected to surface treatment using the surface treatment agent 14, which prevents the adhesion among aggregations 12, allowing the flame retardant 10 to be highly dispersed into the composition containing the organic polymer (matrix polymer). If the organic polymer of the surface treatment agent 14 has the specific melt viscosity or the specific melting point, the surface treatment agent 14 adheres well to the aggregations 12, which further increases the effect of preventing the adhesion among aggregations 12. Thus, the flame-retardant composition excellent in cold resistance and manufacturability can be obtained.

Next, a description of a flame-retardant composition according to a preferred embodiment of the present invention will be provided. The flame-retardant composition according to the preferred embodiment of the present invention contains the flame retardant according to the preferred embodiment of the present invention, and a matrix polymer.

The matrix polymer is not limited specifically. Polyolefin and a styrene copolymer are preferably used as the matrix polymer. To be specific, the examples of the matrix polymer include polyethylene, polypropylene, ethylene-polypropylene rubber and a styrene-ethylene butylene-styrene block copolymer.

The matrix polymer may be modified by acid. Examples of the acid include an unsaturated carboxylic acid and its derivative. To be specific, examples of the unsaturated carboxylic acid include a maleic acid and a fumaric acid. Examples of the derivative include a maleic acid anhydride, a maleic acid monoester and a maleic acid diester. Among them, the maleic acid and the maleic acid anhydride are preferably used. They may be used singly or in combination.

The acid is introduced into the matrix polymer preferably by a grafting method or a direct method (copolymerization method). The amount of the acid-modified matrix polymer is preferably 0.1 to 20% by mass with respect to the full amount of the matrix polymer, more preferably 0.2 to 10% by mass, and still more preferably 0.2 to 5% by mass. If the amount is smaller than the lower limit, cold resistance and wear resistance of the flame-retardant composition tend to decrease. If the amount is larger than the upper limit, a molding property of the flame-retardant composition tends to deteriorate.

The content of the flame retardant is preferably within a range of 30 to 250 parts by mass with respect to 100 parts by mass of the matrix polymer. The content of the flame retardant is more preferably within a range of 50 to 200 parts by mass, and still more preferably within a range of 60 to 180 parts by mass. If the content is less than 30 parts by mass, flame retardancy of the flame-retardant composition tends to decrease. On the other hand, if the content is more than 250 parts by mass, the flame-retardant composition cannot obtain a sufficient mechanical property with ease.

The flame-retardant composition according to the preferred embodiment of the present invention may further contain another additive as appropriate within a range of not impairing the properties of the flame-retardant composition. Examples of the additive, which is not limited specifically, include a general filler used for a covering member of an insulated wire, a coloring agent, an antioxidant and an antiaging agent.

The flame-retardant composition can be prepared by kneading the flame retardant and the matrix polymer, and the additive as necessary with the use of a generally used kneader such as a Banbury mixer, a pressure kneader, a kneading extruder, a twin screw extruder and a roll. In kneading, it is preferable that the matrix polymer is charged and agitated in advance in the kneader, and then the flame retardant is added to the matrix polymer being agitated, or that the flame retardant is charged and agitated in advance in the kneader, and then the matrix polymer is added to the flame retardant being agitated. It is also preferable that the flame retardant and the matrix polymer are dry blended by using a tumbler before kneading, and then transferred into the kneader to knead. After the kneading, the composition is taken out of the kneader. The composition is preferably pelletized using a pelletizing machine.

In the flame-retardant composition according to the preferred embodiment of the present invention, the contained flame retardant has excellent dispersibility. Accordingly, the flame-retardant composition has excellent cold resistance. In addition, a discharge amount of the flame-retardant composition that is discharged from the kneader can be increased, whereby the flame-retardant composition is excellent in manufacturability.

In addition, because the organic polymer tends not to be pyrolyzed compared with a fatty acid that is a conventional surface treatment agent, volatile gas that is generated by the pyrolysis less generates in the process of heat-kneading of the flame-retardant composition containing the flame retardant and the matrix polymer, whereby the materials can be smoothly supplied into the kneader.

Next, a description of an insulated wire according to a preferred embodiment of the present invention will be provided. The insulated wire according to the preferred embodiment of the present invention uses the flame-retardant composition described above for its covering member. The insulated wire may have a configuration such that the covering member is covered directly on a conductor, or a configuration such that an intermediate member or an insulating member is interposed between a conductor and the covering member, like a shielded conductor.

The diameter, the material and other properties of the conductor, which are not limited specifically, may be determined depending on the intended use. The thickness of the covering member, which is not limited specifically, may be determined considering the conductor diameter.

The insulated wire can be prepared by extrusion-covering the conductor with the flame-retardant composition according to the preferred embodiment of the present invention that is kneaded by the generally used kneader such as the Banbury mixer, the pressure kneader and the roll.

### Example

A description of the present invention will now be specifically provided with reference to Examples. However, the present invention is not limited thereto.

(Material Used, Manufacturer, and Other Information)

Materials used in Examples and Comparative Examples are provided below along with their manufacturers, trade names, and other information.
Matrix polymer (polypropylene) [manuf.: JAPAN POLYPROPYLENE CORPORATION, trade name: EC7]
Magnesium hydroxide (aggregation) [manuf.: NIHON KAISUI KAKOU, CO. LTD, trade name: MS-1H]
Surface treatment agent
(a) Polypropylene (PP) [manuf.: SUNALLOMER LTD., trade name: PMA20V]
(b) Polyethylene (PE) [manuf.: JAPAN POLYETHYLENE CORPORATION, trade name: UJ790]
(c) Ethylene-ethyl acrylate copolymer (EEA) [manuf.: MITSUI CHEMICALS, INC., trade name: EV550]
(d) Ethylene-vinyl acetate copolymer (EVA) [manuf.: JAPAN POLYETHYLENE CORPORATION, trade name: LV371]
(e) Stearic acid (reagent)
(f) Zinc stearate (reagent)
(g) Methacrylate silane (reagent)
Antioxidant ([manuf.: CIBA SPECIALTY CHEMICALS INC., trade name: Irganox 1010]

(Preparation of Flame Retardant)

Flame retardants according to Examples and Comparative Examples were prepared as follows. While each magnesium hydroxide was being agitated in a super mixer at a temperature of 200° C., each surface treatment agent shown in Table 1 was gradually poured in the mixer over about 5 minutes. After a predetermined amount of each surface treatment agent was poured, each mixture was agitated for about another 20 minutes. The kinds, contents, melting points (° C.), and melt viscosities (mPa·s) at 140° C. of the surface treatment agents are shown in Table 1. The contents of the surface treatment agents (amounts of the surface treatment agents to be used for surface treatment) show their rates (parts by mass) to 100 parts by mass of the magnesium hydroxide (aggregations). The viscosities shown in Table 1 show melt viscosities (mPa·s) at 140° C. of the surface treatment agents.

(Preparation of Flame-Retardant Composition and Insulated Wire)

Flame-retardant compositions according to Examples and Comparative Examples were prepared by kneading the materials (by the respective parts by mass) shown in Table 1 at a mixing temperature of 200° C. using a twin-screw kneader, and pelletizing the mixtures using a pelletizing machine. Insulated wires according to Examples and Comparative Examples were then prepared by extrusion-covering conductors (cross sectional area: 0.5 mm²), which were soft-copper strands each prepared by bunching seven soft copper wires, with the prepared compositions to have a thickness of 0.2 mm using an extruder.

(Test Procedure)

The discharge amounts (kg/h) of the respective compositions prepared as above were evaluated. In addition, the insulated wires were subjected to a cold-resistance test. The results are shown in Table 1.

(Cold-Resistance Test)

The cold-resistance test was performed in accordance with JIS C3005. To be specific, the prepared insulated wires were cut into test specimens 38 mm long. Five test specimens for each insulated wire were set in a test machine and hit with a striking implement while being cooled, and the temperature at the time when all of the five test specimens broke was determined as the cold-resistance temperature of the insulated wire. The insulated wires having a cold-resistance temperature of −20° C. or less were evaluated as passed.

TABLE 1

| | | | Example | | | | | | | Comparative Example | | |
|---|---|---|---|---|---|---|---|---|---|---|---|---|
| | | | 1 | 2 | 3 | 4 | 5 | 6 | 7 | 1 | 2 | 3 |
| | Melting | | Matrix polymer | | | | | | | | | |
| Flame retardant | point | Viscosity | 100 | 100 | 100 | 100 | 100 | 100 | 100 | 100 | 100 | 100 |
| Surface-treated with | 60 | 800 | 100 | — | — | — | — | — | — | — | — | — |
| 0.1 parts by mass of PP | | | | | | | | | | | | |
| Surface-treated with | 60 | 500 | — | 100 | — | — | — | — | — | — | — | — |
| 10 parts by mass of PP | | | | | | | | | | | | |
| Surface-treated with | 70 | 300 | — | — | 100 | — | — | — | — | — | — | — |
| 0.1 parts by mass of PE | | | | | | | | | | | | |
| Surface-treated with | 70 | 500 | — | — | — | 100 | — | — | — | — | — | — |
| 10 parts by mass of PE | | | | | | | | | | | | |
| Surface-treated with | 80 | 600 | — | — | — | — | 100 | — | — | — | — | — |
| 5 parts by mass of EEA | | | | | | | | | | | | |
| Surface-treated with | 90 | 200 | — | — | — | — | — | 100 | — | — | — | — |
| 5 parts by mass of EVA | | | | | | | | | | | | |
| Surface-treated with | 90 | 100 | — | — | — | — | — | — | 100 | — | — | — |
| 5 parts by mass of Metalbcene PE | | | | | | | | | | | | |
| Surface-treated with | | | — | — | — | — | — | — | — | 100 | — | — |
| 5 parts by mass of Stearic acid | | | | | | | | | | | | |
| Surface-treated with | | | — | — | — | — | — | — | — | — | 100 | — |
| 5 parts by mass of Zinc stearate | | | | | | | | | | | | |
| Surface-treated with | | | — | — | — | — | — | — | — | — | — | 100 |
| 5 parts by mass of Methacrylate silane | | | | | | | | | | | | |
| Antioxidant | | | 1 | 1 | 1 | 1 | 1 | 1 | 1 | 1 | 1 | 1 |
| Cold resistance (° C.) | | | −30 | −35 | −25 | −35 | −30 | −30 | −25 | −15 | −10 | −10 |
| Discharge amount (kg/h) | | | 500 | 700 | 500 | 650 | 600 | 600 | 550 | 100 | 150 | 150 |

It is found that the covering members of the insulated wires according to Comparative Examples are inferior in cold resistance because the aggregations subjected to surface treatment using the conventional surface treatment agents are used as the flame retardants for the covering members. This is assumed to lie within the inferior dispersibility of the flame retardant into the flame-retardant composition. In addition, it is found that the discharge amounts of the flame-retardant compositions according to Comparative Examples that are discharged from the twin-screw kneader are small, and accordingly the flame-retardant compositions are inferior in manufacturability.

In contrast, it is found that the covering members of all the insulated wires according to Examples are excellent in cold resistance. In addition, it is found that the discharge amounts of the flame-retardant compositions according to Examples that are discharged from the twin-screw kneader are large, and accordingly the flame-retardant compositions are excellent in manufacturability.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1-8. (canceled)

9. A flame retardant comprising:
an aggregation of particles mainly consisting of magnesium hydroxide; and
a surface treatment agent containing an organic polymer, with which a surface of the aggregation is coated.

10. The flame retardant according to claim 9, wherein the organic polymer comprises a resin having a melt viscosity of 1000 mPa·s or less at 140° C.

11. The flame retardant according to claim 10, wherein the organic polymer comprises a resin having a melting point of 100° C. or less.

12. The flame retardant according to claim 11, wherein the organic polymer comprises an olefin resin.

13. The flame retardant according to claim 12, wherein the olefin resin comprises one or a plurality of materials selected from the group consisting of polyethylene, polypropylene, an ethylene-ethyl acrylate copolymer, and an ethylene-vinyl acetate copolymer.

14. The flame retardant according to claim 13, wherein the surface treatment agent content is within a range of 0.1 to 10 parts by mass with respect to 100 parts by mass of the aggregation.

15. The flame retardant according to claim 9, wherein the organic polymer comprises a resin having a melting point of 100° C. or less.

16. The flame retardant according to claim 9, wherein the organic polymer comprises an olefin resin.

17. The flame retardant according to claim 16, wherein the olefin resin comprises one or a plurality of materials selected from the group consisting of polyethylene, polypropylene, an ethylene-ethyl acrylate copolymer, and an ethylene-vinyl acetate copolymer.

18. The flame retardant according to claim 9, wherein the surface treatment agent content is within a range of 0.1 to 10 parts by mass with respect to 100 parts by mass of the aggregation.

19. A flame-retardant composition comprising:
the flame retardant according to claim 14; and
a matrix polymer.

20. A flame-retardant composition comprising:
the flame retardant according to claim 9; and
a matrix polymer.

21. An insulated wire comprising;
a conductor; and
the flame-retardant composition according to claim 19, with which the conductor is covered.

22. An insulated wire comprising;
a conductor; and
the flame-retardant composition according to claim 20, with which the conductor is covered.
